(19) United States
(12) Patent Application Publication
(10) Pub. No.: US 2008/0240425 A1
(43) Pub. Date: Oct. 2, 2008

(54) Data De-Identification By Obfuscation

(75) Inventors: Romer E. Rosales, Downingtown, PA (US); Radu Stefan Niculescu, Malvern, PA (US); William A. Landi, Devon, PA (US); Sriram Krishnan, Exton, PA (US); R. Bharat Rao, Berwyn, PA (US); Phan Hong Giang, Downingtown, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/048,361

(22) Filed: Mar. 14, 2008

Related U.S. Application Data
(60) Provisional application No. 60/896,963, filed on Mar. 26, 2007.

(51) Int. Cl. H04L 9/28

(52) U.S. Cl. 380/28

(57) ABSTRACT

Medical or other data is de-identified by obfuscation. Located instances are replaced. By replacing with values in a same format and level of generality, multiple possible identifications—the replacement values and the instances not located—are provided in the data, obfuscating the original identification. By replacing as a function of a probability, the resulting data set has different instances distributed in a way making identification of the actual or original instances not located by searching more difficult.

### RELATED APPLICATIONS

The present patent document claims the benefit of the filing date under 35 U.S.C. §119(e) of Provisional U.S. Patent Application Ser. No. 60/896,963, filed Mar. 26, 2007, the disclosure of which is hereby incorporated by reference

### BACKGROUND

The present embodiments relate to de-identification of data. In particular, the ability to identify an individual from a data set is reduced.

De-identification is valuable in many contexts. De-identification of various types of information (e.g., personal information) is an important requirement for tasks involving data analysis, display, storage, manipulation, and sharing. Specific areas of use include medical records, financial data, data sharing across organizations, or other uses. For example, medical records are de-identified, which is an important aspect for the implementation of the HIPAA government regulation. Medical records include structured (e.g., tabulated with defined fields) and/or unstructured (e.g., free text) data. To share medical records outside of an organization, the ability to identify patients from the medical records should be reduced or removed.

In medical records with unstructured data, de-identification of personal information is a difficult task. A high level of accuracy in searching for the information may be difficult to achieve. For example when de-identifying unstructured text, basic fields like names and geographic entities may be found using a search algorithm. The search algorithm may not locate all instances of a name or geographic entity. Some instance will in general be missed due to the nature of the search algorithm and the unstructured medical transcript. Due to misspellings, unusual spacing or punctuation, or other variance, many of the instances or occurrences of identifying information may not be located. Search algorithms are usually not fully reliable at finding important pieces to be de-identified.

The located instances may be blanked out or replaced with a generalization (e.g., replace 51 years old with 50-55 years old). However, generalization may result in the data being less useful for analysis. The instances not located may stand out (e.g., “fifty one” standing our where most of the ages are given in five year increments), indicating identifiable information about a patient even after generalization of the located instances. Blanking may highlight identifying information where the search does not locate and blank out at least one instance.

### BRIEF SUMMARY

By way of introduction, the preferred embodiments described below include methods, systems, and instructions for de-identification of medical or other data by obfuscation. Located instances are replaced. By replacing with values in a same format and level of generality, multiple possible identifications—the replacement values and the instances not located—are provided in the data, obfuscating the original identification. By replacing as a function of a probability, the resulting data set has different instances distributed in a way making identification of the actual or original instance more difficult.

In a first aspect, a system is provided for de-identification of medical data by obfuscation. A memory is operable to store a plurality of replacement instances for a first type of identifying attribute associated with medical data. Each of the replacement instances is different, but has a substantially same format and level of generality. A processor is operable to locate a plurality of located instances of the first type of attribute in a collection of the medical data. The located instances have the substantially same format and level of generality. The processor is operable to replace at least one of the located instances with at least one of the replacement instances. A display is operable to display information as a function of the collection of the medical data including the at least one of the replacement instances. Output or storage may be provided instead of display.

In a second aspect, a method is provided for de-identification of data by obfuscation. A dataset is searched for instances of a first type of attribute. In the dataset, the instances are replaced with other values of the first type of attribute. The replacing is a function of a probability.

In a third aspect, a computer readable storage medium has stored therein data representing instructions executable by a programmed processor for de-identification of data by obfuscation. The instructions include finding occurrences of different types of identifying attributes in a database of patient medical records, the finding having an approximate error probability, and replacing the occurrences as a function of the error probability such that a number of instances of at least one replacement values is similar to a number of occurrences not found by the finding.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a flow chart diagram showing one embodiment of a method for de-identification of data by obfuscation; and

FIG. 2 is a block diagram of one embodiment of a system for de-identification of data by obfuscation.

### DETAILED DESCRIPTION OF THE DRAWINGS AND PRESENTLY PREFERRED EMBODIMENTS

Randomized instance replacement for an attribute de-identifies data. The data is structured or unstructured, such as text having grammatical and computer-based structure but not being in pre-defined, tabulated fields. De-identification for obfuscation transforms data by eliminating or replacing a sufficient amount of critical information. The use for data de-identification may determine the level of sufficient replacement and the critical information to be replaced. Critical information is data that would identify a certain entity or entities associated to the data, such as the individual whose personal information is stored in the data. The application or intended use of the de-identified data determines the sufficiency. For example, medical records are transformed so that the medical record does not identify or cannot be used to identify the associated patient. The sufficiency and critical information may be dictated by HIPAA or other standards.

By appropriately manipulating the different pieces of information that could be found by a search algorithm, it is difficult for some external entity to discover any piece of information that can be used for identifying the individual. A critical piece of information may not have been located and replaced, but is obfuscated by the instances of the same attribute that were located and replaced. The transform operates independently to whether critical pieces of information were not located by the search algorithm. In other words, the data manipulation makes it difficult to know whether anything in the processed data is part of the original information, even if the search algorithm could not find all of the important pieces of data to be de-identified. For example, even if a few names or dates of birth were not properly found by the search algorithm, the existence of multiple names or dates of birth results in the inability to identify the correct or actual name or data of birth. The level of obfuscation or transformation may be set or changed.

The attributes of interest are those that can be used to identify the relevant entity, such as a patient, business, or account holder. Similarly, an instance of an attribute is a particular reference or occurrence of the attribute in the data. For example, a patient name (e.g., “Romer”) in the text is an instance of the attribute ‘patient name.’ To de-identify the data, a search algorithm locates instances of the attribute in the data (e.g., locate instances of “Romer” and other names). With some probability, the located instances are replaced with another new instance (e.g., “Bill,” “Stefan,” “Sriram,” “Bharat,” or “Phan”) of the same attribute. The probability may indicate the frequency of replacement (e.g., replace 90% of the located “Romer” instances), the distribution of the randomly selected new instance (e.g., use “Bill” 15%, use “Stefan” 5% . . . ), and/or other probability. In an optional act, one or more of the new instances are altered according to some specified method, such as purposeful misspelling. The process is performed for each attribute of interest. Other useful information contained in the original data is maximally preserved.

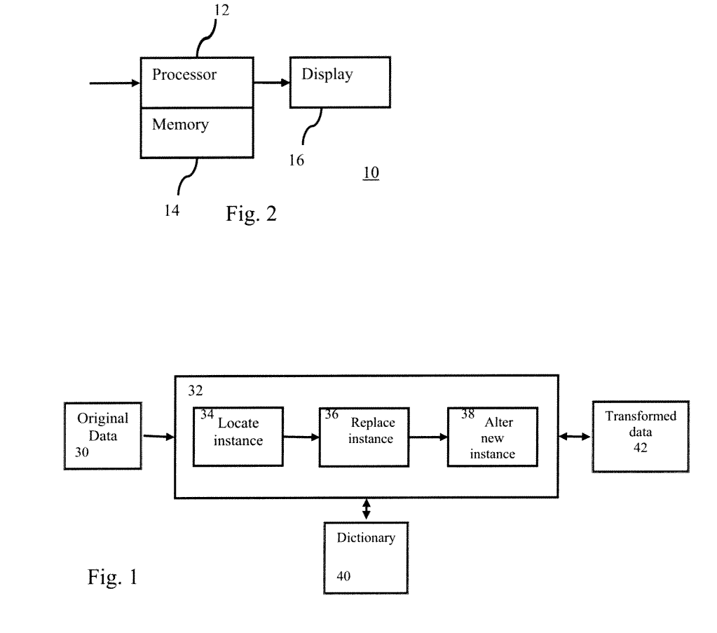

FIG. 1 shows a method for de-identification of data by obfuscation. The method is implemented using the system 10 of FIG. 2 or a different system. Additional, different or fewer acts than shown in FIG. 1 may be provided. For example, act 38 may not be performed. As another example, acts 30, 40 and 42 are not performed or are performed by others. The acts are performed in the order shown or a different order. The acts may be performed automatically, manually, or semi-automatically.

In act 30, a dataset is acquired. The original dataset is acquired within an organization implementing the de-identification. Alternatively, the original dataset is from another organization, such as an organization providing the dataset for analysis by a service organization. The acquired dataset may or may not have been processed, such as data collected from a plurality of separate records and/or data sources.

The dataset is a collection of data. For example, the dataset includes medical records of a hospital, insurance company, accreditation organization, or other medical group. The dataset may include information for single or a plurality of patients. For example, the dataset is for all patients treated at a hospital or a sub-set (e.g., all cancer, all heart attach, all diabetic, all colon cancer over 40 years of age, or other sub-set). Datasets for multiple patients may be used for treatment effectiveness determination, guideline adherence checking, clinical studies, or other purposes. Financial datasets may be used, such as data for banking, insurance, or other account records for one or more account holders. Other datasets for other purposes may be provided.

In act 32, de-identification is performed. The de-identification includes locating instances in act 34, replacing the instances in act 36, and altering the replacements in act 38. Different, additional, or fewer acts may be included, such as the alteration of act 38 being optional.

The de-identification of act 32 uses information acquired in act 40. In act 40, a dictionary or other listing of possible values of one or more attributes is provided. For example, data from a phone book is acquired. The phone book provides values for names (first, middle, last, first-last, first-middle-last), telephony numbers (fax and phone), and geographic entities (addresses and zip codes). One or more lists may be programmed from knowledge, such as ages from 1-125 years. One or more lists may be downloaded or obtained from other databases, such as lists of vehicle related information (VIN numbers, social security numbers, license plate values, addresses, and names). One or more lists may be created by programming, such as randomly assigning nine digit numbers to emulate social security numbers or ten digit numbers to emulate telephony numbers. One or more lists may be of information combined from different sources. Any now known or later developed general or specific source of values for the attributes of interest may be used.

Institution specific information may additionally or alternatively be used. For example, the list of name values contains the known doctor, nurse, and/or patient names to be located in a patient de-identification application. Account number lists from a financial or insurance organization may be used. Other institution specific strings include commonly used identifiers, like hospital name, initials, or abbreviations. Field or area specific lists may be used, such as medical related telephony numbers.

In other embodiments, a listing is not provided. Instead, an algorithm is provided to generate replacement values as needed. For example, an algorithm is used where the instances may be identified by pattern (e.g., phone numbers—(xxx) xxx-xxxx) and replaced by random generation.

In act 34, occurrences of different types of identifying attributes are found in a database. For example, a processor finds occurrences of HIPAA listed identifiers in unstructured text and/or structured information of patient medical records. An algorithm searches for instances of the different attributes. In an alternative embodiment, the occurrences of only one type of attribute are found.

Different values (e.g., “Romer,” and “Stefan”) for each type of attribute are searched. The appropriate list or lists for a given attribute are used. A string or plurality of values for an entity or attribute of interest is searched. The algorithm searches for every instance of every value in the appropriate list or lists.

The searching may be different for different types of attributes. For each attribute of interest, a search algorithm locates instances of the attribute in the data. For example, the algorithm searches for specific values, such as acquired in act 40. The general search method may not only consist of searching for strings identical to those found in the dictionary, but also on approximate searches (e.g., accounting for plural usage, missing prefix/suffix, or other approximations). Other searching may be used, such as using natural language processing tools. Part of Speech Tagging (POS) can be used to identify noun references and increase the probability of recognizing instances of interest, such as by allowing greater approximation as long as only nouns are searched. Other syntax based searching may be used. Pattern recognition can be used to identify patterns of interest, such as addresses (e-mail or geographic), phone numbers, or others. Machine learning methods may learn from a collection of labeled examples. The trained algorithm searches for and locates instances in the dataset. Combinations of one or more of the searching algorithms may be used for a given attribute. For example, the syntax based searching may be used with a value specific search. Different attributes may use the same or different searching algorithm with the same or different settings. Any now known or later developed search may be used.

The searching algorithm may miss some instances. For example, the value may not be known (e.g., not in the list), there may be a misspelling, words may be joined, or a different or erroneous pattern may be used. The search algorithm has a probability of error, Pₑ. The probability of error is the probability of missed instances. The probability has a variance σ². In general, the number of instances recognized by the locate or search component is as high as possible. Identifying the sources of error may allow modification of the searching to avoid the error. However, the algorithm may still perform with some probability of error even after correction. The original attribute value might still be among the unrecognized instances of that attribute in the text, so that Pₑ>0.

The probability of error may be estimated. The probability may be approximate due to the method of estimation or variance between datasets. For example, the search is applied to a labeled or pre-analyzed dataset. The error is calculated from the results. By repeating the application for different labeled datasets, the variance, median, mean, or other characteristic of the probability may be determined. Any labeled dataset may be used. For example, an expert labels a portion of the dataset to which the search algorithm is to be applied. As another example, a representative or sample dataset for the area of application (e.g., medical transcripts or patient records) is labeled. Any level of generality may be used, such as estimating the error for medical data searching to be used for searching data for a specific class of patients. The error may be determined statistically or without labeling of a dataset, such as based on previous studies or analysis of the type of searching algorithm. The probability of error indicates the frequency for which the search algorithm will not identify values of the attribute of interest.

In act 36, one or more located instances in the dataset are replaced. The instances are replaced with other values of the same type of attribute. For example, a located name (e.g., “Romer”) is replaced with another name from the list acquired in act 40 (e.g., “Bill”). Other occurrences of the same or different located name may be replaced with the same or a different replacement. The replacement is of a same type of attribute.

The replacement is performed for one or more different attributes. Instances of each type of attribute are replaced by other values for the respective type of attribute. Values may be alphanumeric, numbers, letters, or have other formats.

The replacement values or instances are different than the value being replaced. In alternative embodiments, the replacement values are randomly selected without limitation on whether the same value is selected as the value to be replaced.

The replacement values have a substantially same format. For example, a phone number with ten digits, parenthesis, and a dash (e.g., (xxx) xxx-xxxx) is replaced by a phone number with identical format or a different format still communicating a phone number (e.g., yyy-yyyy; yyy.yyy.yyyy; or yy yy yy yy yy). Substantially accounts for different ways of communicating the attribute of interest that may be understood to be the attribute with or without incorporated errors. In alternative embodiments, a different format is used, such as replacing an admission date with a number of days from admission.

The replacement values have a substantially same level of generality. For example, an age in years is replaced by an age in years or a birth date providing the age in years. Substantially accounts for different ways of communicating with or without rounding (e.g., 4 may be replaced by 4½ to provide a substantially same level of generality). In alternative embodiments, the level of generality is different, such as condensing ages with year resolution to every five-year resolution (e.g., age of 39 is generalized to age of 35-39). If relative date intervals are to be preserved, the dates recognized by the search algorithm may be shifted by a random amount, but preserving the relative time difference.

Any now known or later developed replacement method may be used. For example, random selection is performed. As another example, a rule based selection is used, such as selecting values with no common letters or numbers or selecting values with a threshold amount of similarity (e.g., at least two letters of the name are the same). In another example, a previously unused value V is uniformly selected with a given predefined probability P_{new} or a previously used value V is uniformly selected with probability (1−P_{new}).

In one embodiment, an instance-based replacement is used. The replacement is a function of a probability. One possible probability is the frequency of replacement of located instances. Less than all of the located instances are replaced. The probability of replacing a located instance is less than one. Some instances may not be replaced. The frequency of replacement may be arbitrary, random, predetermined, or a function of another variable.

Another possible probability is the frequency of use of the replacement. For example, the probability of replacement is set similar or the same as the probability of error of the search algorithm. A number of instances of a given replacement value is similar to a number of occurrences not found by searching. For example, if the probability of error is 10%, then 8-12 replacement values are used for 100 instances. Each replacement value is selected as a function of a probability distribution of the replacement values. A probability distribution has a center or highest frequency at the probability of error or other probability. Given a variance, such as the variance of the probability of error or other variance, a random selection of the number of instances to replace with a given value is made from the distribution. Each selection for replacing a given instance may be based on the probability distribution.

The probability distribution may adapt during use, such as altering the probabilities as a given replacement values is selected. A replacement value is selected for each instance, but the replacement value selected varies as a function of previously selected values. The probability distribution is a function of previous use of the replacement value such that a previously used replacement value in the dataset has a higher probability to be selected than another one of the replacement values not previously used as a replacement in the dataset.

In one embodiment, a located instance is replaced with another new instance of the same attribute with probability Pᵣ. The new instance is drawn at random from a predefined set of instances (replacement values) with a probability distribution Pₐ (instance). In general, Pₐ may depend on any other characteristic of the attribute or on previously drawn instances. The set of instances may depend on or be limited by previously drawn instances.

In another embodiment, the replacement probability substantially matches (e.g., statistically matches based on a normal curve) the error probability of the search algorithm. A significant number (e.g., half or more) of frequencies of the replacement values should be as close as possible to the estimated miss frequency for that attribute. The number of located instances is denoted by N. The expected number of total instances of the attribute is N*(1−Pₑ). This total number includes the instances missed by the search component.

A frequency is selected as a function of the search error probability. A random, previously unused, value V of the attribute is selected from the predefined set of known possible values. A random frequency F for the replacement V is selected from Normal (Pₑ, α*σ²) where α≦1 is a parameter that controls how close F is to the actual search error rate Pₑ. The random frequency F is limited by the normal distribution associated with the error of the search algorithm. Other limits or rules may be used.

A subset of the located instances is selected as a function of the frequency, F. F located instances are selected at random. F*N/(1−Pₑ) of the located instances that have not been replaced previously are randomly selected. The selected instances are replaced with the replacement value V.

Selecting the frequency, selecting the subset, and replacing the instances of the subset are repeated. Each repetition selects different or non-overlapping subsets of not previously replaced located instances. Each repetition replaces the subset for the iteration with a different value than was previously used. The process continues repeating until there are no more located instances to be replaced. For example, the frequency provides a number greater than the number of non-replaced instances. After replacing those remaining instances, the replacement is complete.

The replacement obfuscates the actual identify information. It is difficult for a third party to decide what instances were missed by the search algorithm. If the search error rate Pₑ is greater than 50%, then the de-identification may not be sufficient, since counting may reveal the original instances. A higher accuracy of the locate component helps avoid restricting the space of possibilities to too few choices.

In another embodiment for a dataset with a large number of different values in original instances of an attribute, every occurrence of one or each specific value is replaced with a same replacement value. All the instances found by the searching are collected in a list. Duplicate items are removed from the list. Each unique value of the remaining list is mapped to a new value of the same type. The mapping may be based on a probability, such as a probability of the replacement value in the general or a specific population. The identifiable instances within the data are replaced based on the mapped new value. Each instance using one value is replaced with the same replacement value. This replacement may maintain useful relationships, but still obfuscate the actual identity.

In act 38, at least one of the replacements of the occurrences is altered. The alteration emulates one or more sources of error of the finding or emulates common variation. For example, one or more, but not all, of the replacement values are altered to include a misspelling, plural usage, or inserted space or punctuation.

The alteration may be a function of a noise or other distribution. The alteration provides replacements as a function of a probability. Altering adds noise to the replacement values. By providing one or more distributions of alterations, the alteration may emulate actual data. For example, misspellings occur one in every twenty instances. Accordingly, one in every twenty replacement values are misspelled, such as by replacing, adding, or removing one or more letters. Variance may be used for random alteration as a function of the probability of occurrence of the alteration of interest. Different types of alterations may have different probabilities and associated distributions. The selected alteration may be based on probability. For example, misspelling using the incorrect order of “ie” or “ei” may be more common than misspelling using an “n” instead of an “m.” The “ie” inaccuracy may be used more frequently or have a greater chance of use in the alteration.

The alter component further transforms the inserted instances in order to make these difficult to recognize as different from the original instances. The alteration component may be performed iteratively. For example, an altered value (e.g., replace a letter with another letter) may then be altered again (e.g., remove a letter). The selection of previously altered replacement values may be based on a probability of multiple errors or noise sources occurring or based on different probability distributions for different errors. This approach can be used in general, independently to whether misspellings are actually present. In alternative embodiment, the expected mistakes (e.g. misspellings) are included as valid replacement values in a list for the attribute. The frequency of occurrence in the list and/or a probability associated with randomly selecting the replacement value with a mistake may be used to limit selection of the erroneous replacement value.

In act 42, the de-identified dataset is output. The transformed collection of data may be distributed to others for analysis. The data may be encrypted or other access limited for distribution even though transformed. The distribution may conform to data privacy requirements, such as HIPAA. Access to the data may be provided to those that are not allowed access to the original data. The data may be analyzed without the analysis being faulty in many cases since the replacement values have a similar format and level of generality.

In order for a trusted party to explore the original data given the de-identified data, a log may be used to reverse the changes. The changes or transformations made to the original data are tracked. The resulting log is maintained with enough information to bring the data back to the original non de-identified form. Alternatively, only a portion of the change information is maintained, depending on the user requirements for reversing changes. Only part of the original data may be reconstructed.

FIG. 2 shows a system 10 for de-identification of medical or other data by obfuscation. The system 10 includes a processor 12, a memory 14 and a display 16. Additional, different or fewer components may be provided. The system 10 is a personal computer, workstation, medical diagnostic imaging system, network, super-computer, or other now known or later developed system for data processing. For example, the system is a workstation for analyzing medical patient records. As another example, the system 10 is a computer aided diagnosis system for modeling and/or mining information from a collection of data. The system 10 may belong to an organization responsible for creating and/or maintaining the original data, an organization providing a service (e.g., de-identification or mining from de-identified data), or a research organization (e.g., clinical study). The de-identification is provided by or as a service to the organization providing the data. The de-identification algorithms may be sold as software or a workstation for de-identification. A usage fee may be charged.

The processor 12 is a general processor, digital signal processor, application specific integrated circuit, field programmable gate array, analog circuit, digital circuit, combinations thereof or other now known or later developed processor. The processor 12 may be a single device or a combination of devices, such as associated with a network or distributed processing. Any of various processing strategies may be used, such as multi-processing, multi-tasking, parallel processing or the like. The processor 12 is responsive to instructions stored as part of software, hardware, integrated circuits, firmware, micro-code or the like.

The processor 12 is operable to locate a plurality of located instances of each first type of attribute in a collection of the medical or other data. In one embodiment, the located instances have the substantially same format and/or level of generality as at least some of the replacement instances. The processor 12 replaces at least one of the located instances with at least one of the replacement instances. The replacement may be a function of a probability. For example, the probability is for a probability distribution of the replacement instances. Some of the replacement instances have a higher probability in the distribution if previously used as a replacement in the collection of data. The replacement instances are selected as a function of the probability distribution. As another example, the probability is a function of an error probability in identification of the located instances. The number of uses of a given replacement is selected, at least in part, based on the error of the searching. The replacement may be the same for every occurrence or a subset of the every occurrence of a given value of the located instance. The processor 12 may generate a list of values of the located instances and replaces every occurrence with a same one of the values with a same one of the replacement instances or other limited number of replacement instances.

The processor 12 may alter one or more of the replacement instances in the collection of data. The replacement instances to be altered may be selected as a function of a noise distribution or other distribution. Alternatively, the replacement instances include typical alterations. In other embodiments, no variation is provided.

The processor 12 locates instances for a given type of attribute. Different values of instances are located. The instances for a given type of attribute may have different formats and/or generality. The replacement values used have corresponding levels of format and/or generality. The processor 12 may also locate different values of instances for different types of attributes. Appropriate replacements are provided, such as replacement specific to the type of attribute or even sub-type of attribute.

The memory 14 is a computer readable storage media. Computer readable storage media include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 14 may be a single device or a combination of devices. The memory 14 may be adjacent to, part of, networked with and/or remote from the processor 12.

The memory 14 stores a plurality of replacement instances for a first type of identifying attribute associated with medical or other data. Different groups of replacement instances may be stored for different formats and/or levels of generality for the type of attribute. Replacement instances for other types of attributes may be stored.

The replacement instances are for one or more types of attributes, such as a name, an address (e-mail and/or street), a telephony number (phone and/or fax), an identification number (account number, social security number, patient id, and/or file number), a geographic indicator (zip code, street address, city, state, county, and/or country), age, combinations thereof or other identifiers, such as listed for HIPAA. The replacement instances may or may not include the located instances. For example, a same list is used for searching for instances and for selecting replacements. The selected replacements may or may not be restricted, such as being different than the value to be replaced and/or being of a same category (e.g., Italian name replaced with an Italian name). A plurality of replacement instances is stored for each one of a plurality of other types of identifying attributes.

The memory 12 may store the dataset to be transformed and/or the transformed dataset. For example, the memory 12 is a database at a medical institution. For example, hundreds, thousands or tens of thousands of patient records are obtained and stored. In one embodiment, the records are originally created as part of a clinical study. In other embodiments, the records are gathered independent of a clinical study, such as being collected from one or more hospitals. The patient record is input manually by the user and/or determined automatically. The patient record may be formatted or unformatted. The patient record resides in or is extracted from different sources or a single source. Medical transcripts may be created by people with many different roles, such as physicians, nurses, transcribers, patients, or others. There may or may not be any review prior to saving the free text. Accordingly, medical data may be particularly noisy or have more errors as compared to other free text (e.g., news stories). Searching and expecting to find all instances may not be achieved for medical and other types of data. Any now known or later developed patient record format, features and/or technique to extract features may be used.

The memory 12 may store training data, such as labeled data for determining probabilities, variances, and/or distributions of values. For example, the training data is a collection of two or more previously acquired patient records and corresponding labels or ground truths. Each training set includes all instances, so is associated with 0% or close to 0% error.

The memory 14 may be a computer readable storage media having stored therein data representing instructions executable by the programmed processor 12 for de-identification of data by obfuscation. The memory 14 stores instructions for the processor 12. The processor 12 is programmed with and executes the instructions. The functions, acts, methods or tasks illustrated in the figures or described herein are performed by the programmed processor 12 executing the instructions stored in the memory 14. The functions, acts, methods or tasks are independent of the particular type of instructions set, storage media, processor or processing strategy and may be performed by software, hardware, integrated circuits, firmware, micro-code and the like, operating alone or in combination. The instructions are for finding occurrences of one or more identifying attributes, replacing at least some of the occurrences with other values of the attributes, and optionally altering one or more of the replacements. The replacing may be performed as a function of one or more probabilities to more closely match the replacements with actual data so that it is more difficult to identify the actual identification.

The display 16 is a CRT, monitor, flat panel, LCD, projector, printer, or other now known or later developed display device for outputting determined information. For example, the processor 12 causes the display 16 at a local or remote location to display information as a function of the collection of the medical data including at least one of the replacement instances. The text of the transformed data may be output. A log of changes may be output. Analysis results based on the transformed data may be output, such as associated with a clinical study. A comparison of the dataset before and after transformation may be output.

In addition or as an alternative to output on the display 16, the data is stored or transmitted. The de-identified collection of data may be communicated for analysis or other use.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A system for de-identification of medical data by obfuscation, the system comprising:
a memory operable to store a plurality of replacement instances for a first type of identifying attribute associated with medical data, each of the replacement instances being different and having a substantially same format and level of generality;
a processor operable to locate a plurality of located instances of the first type of attribute in a collection of the medical data, the located instances having the substantially same format and level of generality as at least some of the replacement instances, and operable to replace at least one of the located instances with at least one of the replacement instances; and
a display operable to display information as a function of the collection of the medical data including the at least one of the replacement instances.

2. The system of claim 1 wherein the first type of attribute is a name, and wherein each of the replacement instances is a different name.

3. The system of claim 2 wherein the memory is operable to store plurality of replacement instances for each one of a plurality of other types of identifying attributes, the other types of identifying attributes including an address, a telephony number, an identification number, a geographic indicator, or combinations thereof, and wherein the processor is operable to locate located instances of each of the other types of identifying attributes and operable to replace at least one of each of the located instances of the other types of identifying attributes.

4. The system of claim 1 wherein the processor is operable to replace as a function of a probability.

5. The system of claim 4 wherein the probability comprises a probability distribution of the replacement instances, the one of the replacement instances having a higher probability in the distribution if previously used as a replacement in the collection of data, the processor operable to select the one of the replacement instances as a function of the probability distribution.

6. The system of claim 4 wherein the probability is a function of an error probability in identification of the located instances.

7. The system of claim 1 wherein the processor is operable to generate a list of values of the located instances and is operable to replace every occurrence with a same one of the values with a same one of the replacement instances.

8. The system of claim 1 wherein the processor is operable to alter one or more of the at least one replacement instances replacing located instances in the collection of data.

9. The system of claim 8 wherein the processor selects the one or more as a function of a noise distribution.

10. A method for de-identification of data by obfuscation, the method comprising:
searching for instances of a first type of attribute in a dataset; and
replacing, in the dataset, the instances with other values of the first type of attribute, the replacing being a function of a probability.

11. The method of claim 10 wherein searching comprises value searching, pattern recognition, part-of-speech tagging, or combinations thereof.

12. The method of claim 10 wherein searching comprises searching for different values of the first type of attribute and different values for other types of attributes, and wherein replacing comprises replacing the different values of the first type of attribute with the other values, the other values including or not including the different values and replacing the different values of the other types of attributes with other values of the other types of attributes.

13. The method of claim 10 wherein replacing as a function of the probability comprises replacing less than all of the instances.

14. The method of claim 10 wherein replacing as a function of the probability comprises selecting each of the other values as a function of a probability distribution of the other values.

15. The method of claim 14 wherein the probability distribution is a function of previous use of the other values such that a previously used other value as a replacement in the dataset has a higher probability than another one of the other values not previously used as a replacement in the dataset.

16. The method of claim 10 wherein replacing comprises every occurrence of one value of the first type of attribute in the instances with one value of the other values.

17. The method of claim 10 further comprising:
altering the other values as a function of a noise distribution.

18. The method of claim 10 wherein replacing as a function of the probability comprises:
selecting a frequency as a function of the probability, the probability being of errors in the searching;
selecting a subset of the instances as a function of the frequency;
replacing the instances of the subset with a first value; and
repeating the selecting the frequency, selecting the subset, and replacing the instances of the subset for different instances and different values.

19. In a computer readable storage medium having stored therein data representing instructions executable by a programmed processor for de-identification of data by obfuscation, the instructions comprising:
finding occurrences of different types of identifying attributes in a database of patient medical records, the finding having an approximate error probability; and
replacing the occurrences as a function of the error probability such that a number of instances of at least one replacement values is similar to a number of occurrences not found by the finding.

20. The computer readable media of claim 19 further comprising:
altering at least one of the replacements of the occurrences, the alteration emulating a source of error of the finding.
